(19) United States
(12) Patent Application Publication
(10) Pub. No.: US 2024/0346377 A1
(43) Pub. Date: Oct. 17, 2024

(54) MACHINE LEARNING-BASED SUPPLY CHAIN PERFORMANCE PREDICTIONS

(71) Applicant: Kraft Foods Group Brands LLC, Chicago, IL (US)

(72) Inventors: Samrendra Kumar Singh, Bolingbrook, IL (US); Diego Barros da Fonseca, Elmhurst, IL (US); Carlos Alexandre Dias de Moura, Utrecht (NL); Socrates Krishnamurthy, Aurora, IL (US); Clare O'Neill Kane, College Park, MD (US)

(21) Appl. No.: 18/633,823

(22) Filed: Apr. 12, 2024

Related U.S. Application Data
(60) Provisional application No. 63/459,503, filed on Apr. 14, 2023.
(60) Provisional application No. 63/459,505, filed on Apr. 14, 2023.

(51) Int. Cl. G06N 20/00; G06Q 10/0637

(52) U.S. Cl. CPC G06N 20/00; G06Q 10/0637

(57) ABSTRACT

Historical information features that each comprise a supply chain performance indicator (such as a case fill rate performance indicator) for each of a plurality of different temporal windows are accessed and then at least some of the historical information features are weighted differently for at least some of the historical information features according to at least a first criterion to provide a training corpus. At least one machine learning model can then be trained using the training corpus to generate a machine learning model (or models) that are configured to predict supply chain performance.

This application claims benefit of U.S. Provisional Application No. 63/459,503 filed Apr. 14, 2023, and U.S. Provisional Application No. 63/459,505 filed Apr. 14, 2023, which are hereby incorporated herein by reference in its entirety.

### TECHNICAL FIELD

These teachings relate generally to the employment of artificial intelligence and more particularly to the use of machine learning models.

### BACKGROUND

Supply chain management sometimes includes attempting to understand (and accordingly plan for) future needs and corresponding supplies to meet those needs. Key performance indicators of one sort or another are sometimes employed to facilitate and/or measure the functioning of a logistics organization.

Supply chain managers, with or without the aid of computerized support, produce metrics to describe those anticipated future needs and expected available corresponding supplies. For example, looking three weeks ahead for a given product, a manager might determine that demand will be X that week for that product while available inventory will be X-Y (i.e., some amount less than anticipated demand). While typically useful information, the applicant has determined that such information may not be completely reliable, and that having a sense of how reliable (or unreliable) such conclusions may be can itself be a helpful consideration when managing a corresponding supply chain.

### BRIEF DESCRIPTION OF THE DRAWINGS

The above needs are at least partially met through provision of the machine

learning-based supply chain performance predictions described in the following detailed description, particularly when studied in conjunction with the drawings, wherein:

FIG. 1 comprises a timeline as configured in accordance with various

embodiments of these teachings;

FIG. 2 comprises a schematic representation as configured in accordance with various embodiments of these teachings;

FIG. 3 comprises an index as configured in accordance with various embodiments of these teachings;

FIG. 4 comprises a timeline as configured in accordance with various embodiments of these teachings;

FIG. 5 comprises a graph as configured in accordance with various embodiments of these teachings;

FIG. 6 comprises a timeline and graph as configured in accordance with various embodiments of these teachings;

FIG. 7 comprises a schematic representation as configured in accordance with various embodiments of the invention; and

FIG. 8 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, these various embodiments will accommodate accessing historical information features that each comprise a supply chain performance indicator (such as a case fill rate performance indicator) for each of a plurality of different temporal windows, weighting at least some of the historical information features differently for at least some of the historical information features according to at least a first criterion to provide a training corpus, and then training at least one machine learning model using the training corpus to generate a machine learning model (or models) configured to predict supply chain performance.

By one approach, the aforementioned first criterion comprises temporal proximity of each of the different temporal windows to a target temporal window (such as, but not limited to, a future temporal window). By one approach the aforementioned weighting of at least some of the historical information features differently for at least some of the historical information features according to at least a first criterion comprises, at least in part, weighting at least one of the different temporal windows that is closer to the future temporal window higher than another of the different temporal windows that is further from the future temporal window.

By one approach, the aforementioned first criterion comprises a weeks-of-stock parameter as corresponds to each of the different temporal windows. In such a case, the weighting at least some of the historical information features differently for at least some of the historical information features according to at least a first criterion can comprise, at least in part, weighting at least one of the different temporal windows having a weeks-of-stock parameter that is sufficiently similar to a weeks-of-stock parameter for a future temporal window higher than another of the different temporal windows having a weeks-of-stock parameter that is less similar to the weeks-of-stock parameter for the future temporal window.

Accordingly, by one approach, these teachings will accommodate a control circuit that is configured as at least one supply chain performance prediction machine learning model that has been trained, at least in part, with a training corpus formed by accessing historical information features that each comprise a supply chain performance indicator for each of a plurality of different temporal windows and weighting at least some of the historical information features differently for at least some of the historical information features according to at least a first criterion.

If desired, such a supply chain performance prediction machine learning model can be further configured to calculate at least one supply chain performance indicator threshold (for example, by, at least in part, analyzing historical relationships between a case fill rate metric and a weeks of supply metric and then calculating the at least one supply chain performance indicator threshold as a weeks of supply metric threshold that identifies a favorable future case fill rate metric).

By one approach, then, these teachings will further accommodate inputting information to a supply chain performance prediction machine learning model that has been trained, at least in part, with a training corpus formed by accessing historical information features that each comprise a supply chain performance indicator for each of a plurality of different temporal windows and weighting at least some of the historical information features differently for at least some of the historical information features according to at least a first criterion and then outputting from the supply chain performance prediction machine learning model a supply chain performance prediction regarding a future temporal window.

By one approach, such a supply chain performance prediction machine learning model can be configured to calculate at least one supply chain performance indicator threshold.

By another approach, in lieu of the foregoing or in combination therewith, such a supply chain performance prediction can comprise, at least in part, a weeks of supply metric that results in a favorable case fill rate metric for the future temporal window.

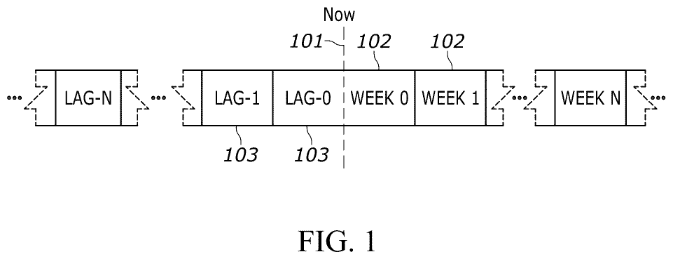

These and other benefits may become clearer upon making a thorough review and study of the following detailed description. Referring now to the drawings, and in particular to FIG. 1, an example of an illustrative temporal context will first be presented.

As discussed herein, these teachings refer to predicting supply chain circumstances/performance during different temporal windows. For the sake of a useful illustrative example, and without intending to suggest any limitations with respect to the duration or periodicity of these windows (or even whether the windows are all of a similar duration), the following description presumes that the temporal windows of interest are each of one week (i.e., seven consecutive days) in duration. Beginning from “now” 101 (i.e., a current time frame), future temporal windows 102 (i.e., in this example, “weeks”) can be denoted consecutively and serially as week 0, week 1, and so forth to week N (where “N” is an integer) or beyond. For many application settings it will be useful and beneficial to provide for 52 such weeks, but that number can be readily varied as desired. And looking backwards from “now” 101, past temporal windows 103 (again, in this example, “weeks”) are consecutively denoted as lag −0, lag '11, and so forth to lag −N or beyond as desired. (“Lag” is described in more detail below where appropriate.)

Generally speaking, these teachings pertain to making supply chain predictions for each of a plurality of future temporal windows (in this case, weeks) and assessing how confident one may feel about such predictions. That indication of confidence can then be leveraged in any of a variety of ways.

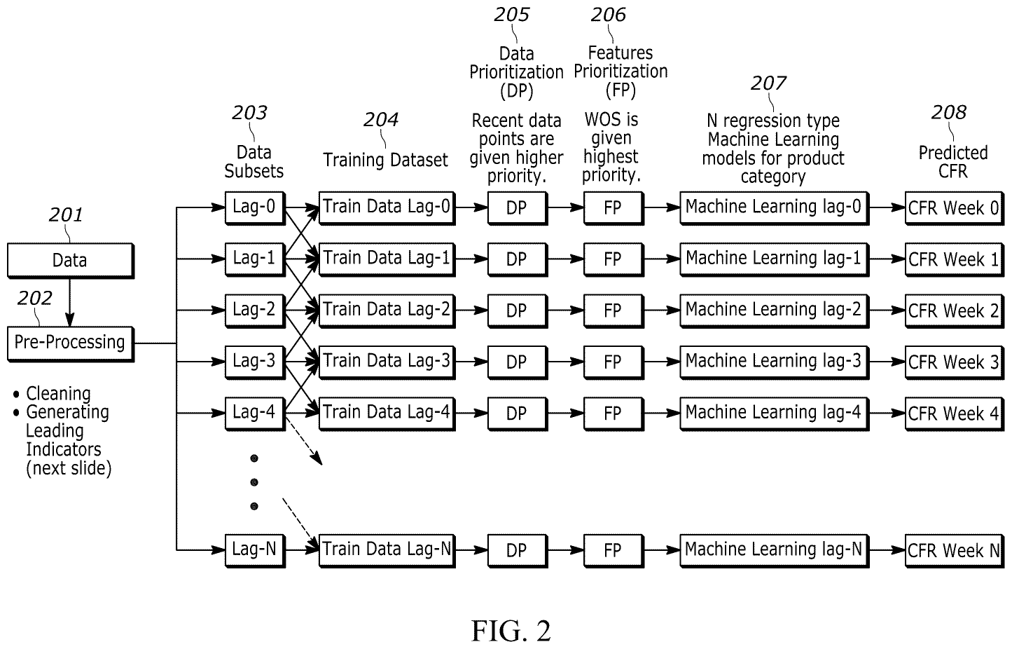

Referring now to FIG. 2, an approach to estimating/predicting a supply chain key performance indicator will be described. In this example, and for the sake of illustration, the key performance indicator is case fill rate (CFR). Case fill rate represents the difference between how much product a customer ordered versus how much is actually shipped. For example, if a customer orders 100 cases of an item but only 90 cases are actually shipped, the case fill rate of that item in that situation is 90%. If one can accurately predict future CFR risk (i.e., that an undesirable mismatch between order and fulfillment is predicted), a proactive organization is better able to prevent the risk from actualizing.

The approach presented in FIG. 2 includes accessing data 201. This data 201 may comprise past planning data for every so-called snapshot week and every so-called fiscal week during some prior period of interest (such as the past one year). A snapshot week is a week during which the planners made a corresponding plan as regards fulfilling anticipated orders and fiscal weeks refers to future weeks (i.e., in the future as compared to the corresponding snapshot week) to which the aforementioned plan applies.

The difference between a fiscal week and a corresponding week (such as, but not limited to, a snapshot week) is called lag.

In this example it is presumed that the planners make/adjust plans every week. These plans are formed as a function of demand, production, and inventory. As will be described in detail, this approach compares the planner's past projections against the actual achieved numbers (i.e., results) and facilitates correcting current plans.

By one approach, and as illustrated, some or all of that data 201 can be subjected to pre-processing 202. This pre-processing 202 can vary with the needs and/or opportunities presented by a given application setting. Generally speaking, the data 201 may be cleaned to, for example, remove extraneous or duplicative content, correct syntax and/or formatting, and so forth.

By one approach this pre-processing 202 can also comprise the generation of leading indicators. Leading indicators capture the inertia in the corresponding supply chain. For example, if the new stock arrival is not available to ship the same week, and can only ship no sooner than a week after the arrival, a last-week inventory can be a better indicator than current-week inventory. During pre-processing 202, this approach will accommodate creating features from, for example, the previous four weeks. These features can allow the downstream machine learning model to learn the upwards or downwards trend that leads up to the current week. As one illustrative example in these regards, consider weeks of supply (WOS) (described in more detail herein), Demand, Production, and CFR as four variables of interest. Useful corresponding machine learning features can then be:
WOS_{wk-4}, WOS_{wk-3}, WOS_{wk-2}, WOS_{wk-1}, WOS_{wk}, Demand_{wk-4}, Demand_{wk-3}, Demand_{wk-2}, Demand_{wk-1}, Demand_{wk}, Production_{wk-4}, Production_{wk-3}, Production_{wk-2}, Production_{wk-1}, Production_{wk}, CFR_{wk-4}, CFR_{wk-3}, CFR_{wk-2}, CFR_{wk-1}

Segregated data subsets 203 for a single given product (as corresponds, for example, to a single stock keeping unit (SKU) number) for each of the relevant lag windows can then be drawn and formed from the forgoing (optionally pre-processed) data 201. In particular, a data subset 203 can be formed for each of lag−0, lag−1, lag−2, and so forth sequentially to lag−N.

Training datasets (i.e., a training corpus for a corresponding machine learning model) 204 are then formed using the foregoing data subsets 203. Generally speaking, in this illustrative example, each training dataset 204 is formed from two or three of the data subsets 203. For example, the training dataset denoted as “Train data lag−1” is formed by compiling the data subsets for Lag−0, Lag−1, and Lag−2 and the training dataset denoted as “Train data lag−3” is formed by compiling the data subsets for Lag−2, Lag−3, and Lag−4. FIG. 2 illustrates that, in this example, the sequentially first and last training datasets are formed using only two of the data subsets 203.

As denoted by reference numeral 205, this approach can then provide for data prioritization. Generally speaking, this activity serves to convey higher priority to certain data points (such as, for example, more temporally recent data points as versus more temporally distant data points).

And as denoted by reference numeral 206, this approach can provide for features prioritization. In this illustrative example, this prioritization leverages a weeks of supply (WOS) metric. The weeks of supply metric measures the relationship between inventory and demand, in particular, how many weeks of demand a given inventory will cover.

For example, if one will end a current week with 100 cases of inventory and demand for the following week is for 40 cases of inventory, and demand for the next following week is 60 cases of inventory, the WOS would be 2. If, however, upcoming demand for that same 100 cases of inventory was 20 cases of inventory for each of the next consecutive following weeks, that same 100 cases would equate to a WOS value of 5. (It may be noted here that the applicant has determined that leveraging the relationship between historical WOS and historical CFR when making future CFR predictions creates a more sophisticated and accurate model than if one simply uses the relationship between historical CFR and inventory.)

A threshold WOS, to achieve, for example, 95% case fill rate, can be calculated based on historical data. By one approach, a WOS closer to this threshold should be also close to 95% case fill rate, and vice-versa. One can calculate the case fill rate for future weeks based on proximity to such a threshold value. A case fill rate calculated with this method has higher accuracy when the WOS is close to the threshold value and, conversely, accuracy drops as WOS diverges away from such a threshold value.

With the foregoing in mind, data for more recent weeks can be accorded higher weightage than weeks that are further out. Threshold values such as 95%, 80%, and 65% can be calculated. Three case fill rates can be calculated based on proximity to these threshold values. A weightage can then be assigned to these case fill rates based on their relative proximity to a corresponding threshold value. For example, if a predicted case fill rate comes out to be 72% based on the 95% threshold, then that case fill rate appears untrustworthy and the weightage accorded to that case fill rate can be zero or close to zero. When, however, the case fill rate is equal to 81% based on the 80% threshold, the results appears more trustworthy and the case fill rate can be assigned a higher weightage.

At reference numeral the (optionally prioritized) training datasets 204 for each Lag window are then used to train a machine learning model. To be clear, and as averred to earlier, this occurs on a product-by-product basis, such that there can be a separate trained machine learning model for each product in a total inventory that comprises, for example, hundreds of thousands individual products.

Those skilled in the art understand that machine learning comprises a branch of artificial intelligence. Machine learning typically employs learning algorithms such as Bayesian networks, decision trees, nearest-neighbor approaches, and so forth, and the process may operate in a supervised or unsupervised manner as desired. Deep learning (also sometimes referred to as hierarchical learning, deep neural learning, or deep structured learning) is a subset of machine learning that employs networks capable of learning (often supervised, in which the data consists of pairs (such as input_data and labels) and the aim is to learn a mapping between the input_data and the associated labels) from data that may at least initially be unstructured and/or unlabeled. Deep learning architectures include deep neural networks, deep belief networks, recurrent neural networks, and convolutional neural networks. Many machine learning algorithms build a so-called “model” based on sample data, known as training data or a training corpus, in order to make predictions or decisions without being explicitly programmed to do so.

In the present example, it will be presumed that the machine learning model comprises an N-regression type of machine learning model. An N-regression type of machine learning model is a type of regression model that involves predicting a numerical target variable based on multiple input features. The term “N” refers to the number of input features used to make the prediction. In N-regression, the model learns a mathematical relationship between the input features and the target variable by minimizing the difference between the predicted and actual values of the target variable. The goal is to develop a model that can accurately predict the target variable for new instances based on their input features.

As denoted by reference numeral 208, each trained machine learning model then outputs a predicted case fill rate for a corresponding future week (such as week 0, week 1, week 2, and so forth). The foregoing approach can be undertaken as frequently or infrequently (and as periodically (such as, for example, weekly) or as randomly as may be appropriate to a given application setting.

It will therefore be understood and appreciated that these teachings provide an effective way to meaningfully utilize and leverage past prediction results to better assess/establish future predictions.

A more detailed example in these regards will now be presented. It will be understood that the details of this example are intended to serve an illustrative purpose and are not intended to suggest any limitations with respect to the practice of these teachings.

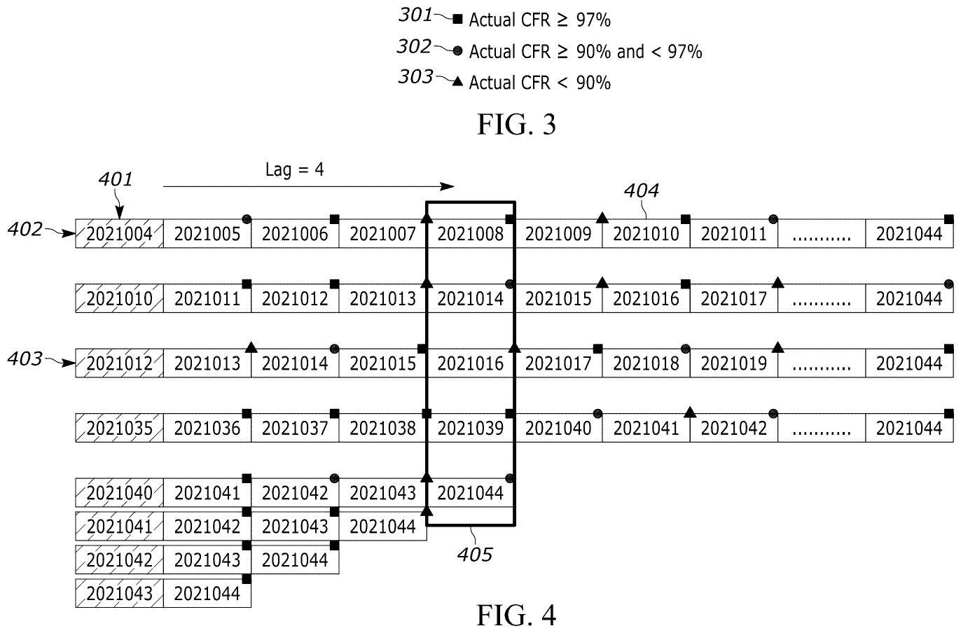

With reference to FIG. 3, three geometric icons serve to indicate a past temporal window for which a corresponding prediction for case fill rate was accurate to a given percentage level. Accordingly, in the following example, a square 301 indicates a resultant actual case fill rate that was accurate within 97% or better. A circle 302 indicates a resultant actual case fill rate that was accurate within a range of 90% up to 97%. And a triangle 303 indicates a resultant actual case fill rate that was less than 90% accurate.

FIG. 4 presents a series of time frames that each begin with a particular past snapshot week 401. For example, the first row 402 begins with a snapshot week 401 for the 4^{th} week of the year 2021 while the third row 403 begins with a snapshot week 401 for the 12^{th} week of the year 2021. In each row, and extending to the right from the corresponding snapshot week 401, are lag weeks. One of the geometric icons described above serves in this example to indicate the accuracy of the case fill rate that was predicted for each particular week. For example, in the first tow 402, the week corresponding to Lag=6 (i.e., the 10^{th} week of the year 2021) has a square-shaped geometric icon representing an accuracy result of greater than or equal to the 97^{th} percentile.

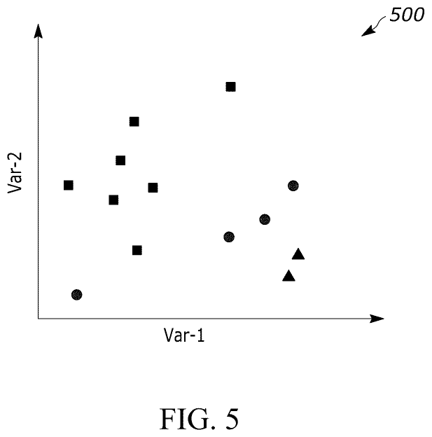

In this illustrative example, the current focus is on the weeks that correspond to Lag=4 (as collectively represented by the bounding box denoted by reference numeral 405). FIG. 5 graphically represents historical case fill rates that correspond to the Lag=4 weeks in a graph 500 defined by a first variable for the X axis and a second variable for the Y axis. Only two variables/two-dimensions are shown here for the sake of clarity and simplicity. In a typical application setting, considerably more variables are considered by the machine learning modeled can be utilized as well.

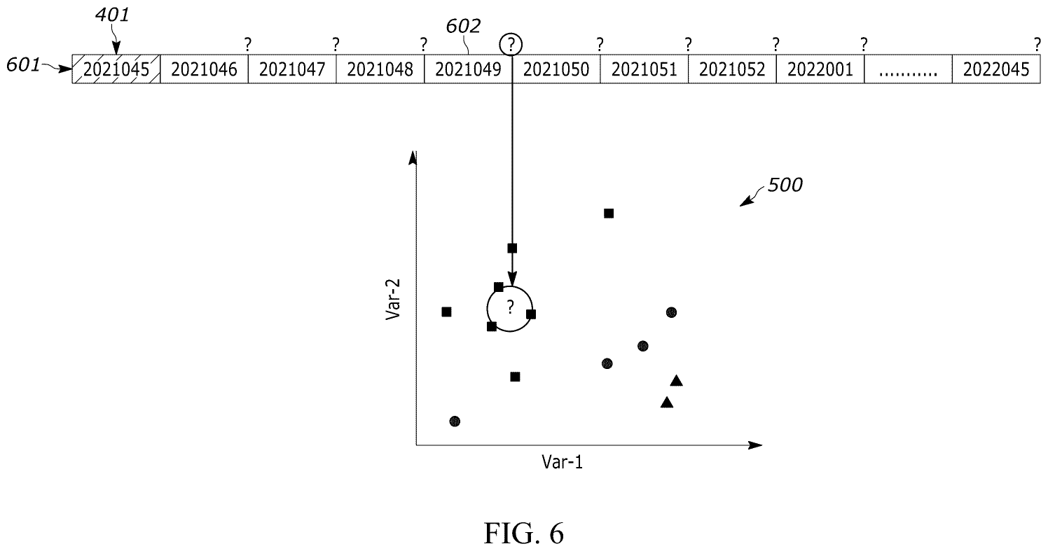

FIG. 6 presents a timeline 601 that begins with a snapshot week 401 that is the current week (in this illustrative example, the 45th week of 2021; it may be noted that the timelines depicted in FIG. 4 conclude with the 44^{th} week of that same year, just prior to the current week. Accordingly, in this example, the past history in consideration begins with the 4^{th} week of the year 2021 and concludes with the 44^{th} week of the same year that is just prior to the current week that is serving as the snapshot week for now predicting future case fill rates on a future-looking weekly basis.

As noted above, this example focuses on a history pertaining especially to Lag=4. That is because, in this example, the goal is to establish a case fill rate prediction for a future week that is 4 weeks beyond the snapshot week (that 4^{th} week being denoted by reference numeral 602. As illustrated by the graph 500 (as was presented above in FIG. 5), the goal is to determine where the predicted case fill rate may be placed in terms of likely accuracy.

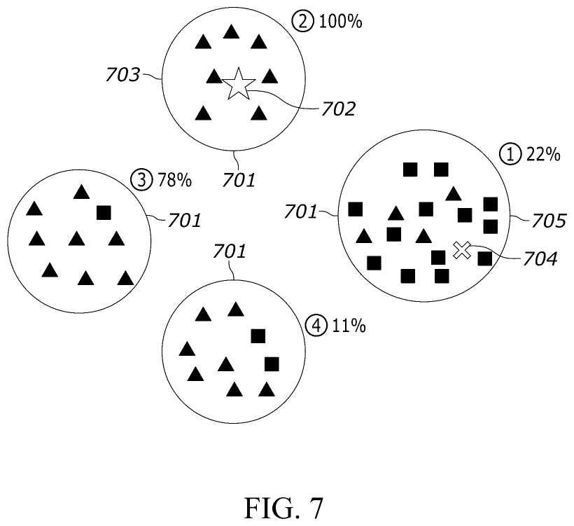

FIG. 7 serves to graphically illustrate estimating a confidence level for a predicted case fill rate using unsupervised learning as described herein. In this example, the features for the utilized datapoints can be such things as demand, production, inventory, transportation, and so forth. In this example, one can divide the historical weeks (see FIG. 4) into n clusters based on the features similarity. The probability of serviceability disruption for a future week can be calculated based on which cluster that future week resembles. (Note that, in this example, Lag is not used as a feature.)

In FIG. 7, each geometric shape represents a historical week along with an indication of that week's corresponding case fill rate prediction accuracy. One historical week can be made up of several input features and 1 output (i.e., case fill rate). The weeks are divided into n clusters (generally denoted by reference numeral 701) using an unsupervised learning method as described herein. The cluster membership of a future week is calculated and the probability of disruption can then be calculated based on how many times serviceability was disrupted (disruptions being represented by the triangle-shaped geometric icons) in any given cluster.

For example, if the future week (represented as a star-shaped icon denoted by reference numeral 702 falls within cluster 2 (denoted by reference numeral 703), one can confidently predict that there is a 100% chance of service failure. If, however, the future week (represented as an X-shaped icon denoted by reference numeral 704) falls within cluster 1 (denoted by reference numeral 705), then one can say there is only a 22% chance of service failure.

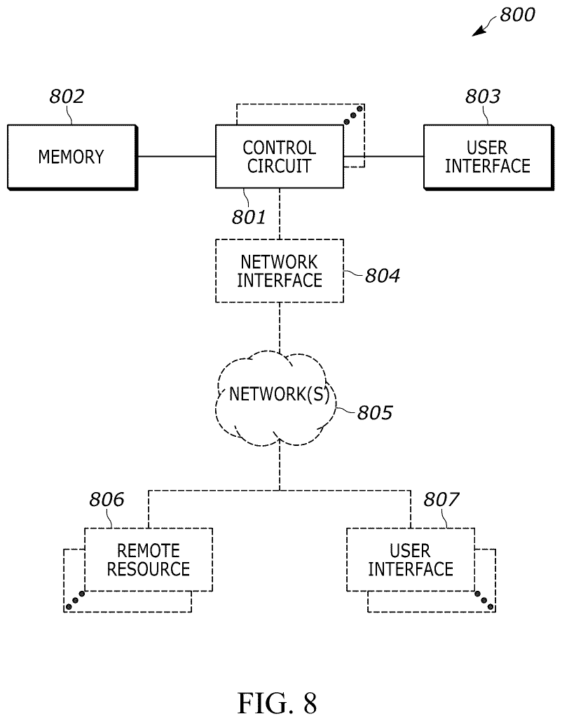

Various illustrative examples of an enabling apparatus 800 to support the foregoing teachings will now be described with reference to FIG. 8.

For the sake of an illustrative example it will be presumed here that one or more control circuits 801 of choice carry out the actions, steps, and/or functions described herein. Being a “circuit,” the control circuit 801 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 801 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 801 is configured (for example, by using corresponding programming as will be well understood by those skilled in the art) to carry out one or more of the steps, actions, and/or functions described herein.

In this example the control circuit 801 operably couples to a memory 802. This memory 802 may be integral to the control circuit 801 or can be physically discrete (in whole or in part) from the control circuit 801 as desired. This memory 802 can also be local with respect to the control circuit 801 (where, for example, both share a common circuit board, chassis, power supply, and/or housing) or can be partially or wholly remote with respect to the control circuit 801 (where, for example, the memory 802 is physically located in another facility, metropolitan area, or even country as compared to the control circuit 801). It will also be understood that this memory 802 may comprise a plurality of physically discrete memories that, in the aggregate, store the pertinent information that corresponds to these teachings.

In addition to the aforementioned historical data, this memory 802 can serve, for example, to non-transitorily store the computer instructions and machine learning model(s) that, when executed by the control circuit 801, cause the control circuit 801 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random access memory (DRAM).)

In this example, the control circuit 801 also operably couples to a user interface 803. This user interface 803 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user. So configured, information output by the described process can be presented to a user to thereby facilitate, for example, assessing the likely veracity of a given case fill rate prediction for a given future time period

By one optional approach, the control circuit 801 can also operably couple to a network interface 804. So configured the control circuit 801 can communicate with other elements (both within the apparatus 800 and external thereto) via the network interface 804. In particular, the control circuit 801 can communicate via one or more intervening networks 805 (such as, but not limited to, the well-known Internet) with one or more remote resources 806 (such as, for example, servers that provide some or all of the aforementioned historical data) and/or one or more remote user interfaces 807 (to thereby enable, for example, communicating the prediction results described herein to one or more remote users). Network interfaces, including both wireless and non-wireless platforms, are well understood in the art and require no particular elaboration here.

Those skilled in the art will recognize that a wide variety of modifications, alterations, and combinations can be made with respect to the above described embodiments without departing from the scope of these teachings. For example, these teachings may be employed in a beneficial way with other key performance indicators as well. Accordingly, such modifications, alterations, and combinations are to be viewed as being within the ambit of the inventive concept.

What is claimed is:

1. A computer-implemented method of training a machine learning model for predicting supply chain performance, comprising:
accessing historical information features that each comprise a supply chain performance indicator for each of a plurality of different temporal windows;
weighting at least some of the historical information features differently for at least some of the historical information features according to at least a first criterion to provide a training corpus;
training a machine learning model using the training corpus to generate a machine learning model configured to predict supply chain performance.

2. The computer-implemented method of claim 1 wherein the supply chain performance indicator comprises a case fill rate performance indicator.

3. The computer-implemented method of claim 1 wherein the first criterion comprises temporal proximity of each of the different temporal windows to a target temporal window.

4. The computer-implemented method of claim 3 wherein the target temporal window comprises a future temporal window.

5. The computer-implemented method of claim 4 wherein weighting at least some of the historical information features differently for at least some of the historical information features according to at least a first criterion comprises, at least in part, weighting at least one of the different temporal windows that is closer to the future temporal window higher than another of the different temporal windows that is further from the future temporal window.

6. The computer-implemented method of claim 1 wherein the first criterion comprises a weeks-of-stock parameter as corresponds to each of the different temporal windows.

7. The computer-implemented method of claim 6 wherein weighting at least some of the historical information features differently for at least some of the historical information features according to at least a first criterion comprises, at least in part, weighting at least one of the different temporal windows having a weeks-of-stock parameter that is sufficiently similar to a weeks-of-stock parameter for a future temporal window higher than another of the different temporal windows having a weeks-of-stock parameter that is less similar to the weeks-of-stock parameter for the future temporal window.

8. An apparatus comprising:
a memory;
a control circuit operably coupled to the memory and configured as a supply chain performance prediction machine learning model that has been trained, at least in part, with a training corpus formed by accessing historical information features that each comprise a supply chain performance indicator for each of a plurality of different temporal windows and weighting at least some of the historical information features differently for at least some of the historical information features according to at least a first criterion.

9. The apparatus of claim 8 wherein the supply chain performance indicator comprises a case fill rate performance indicator.

10. The apparatus of claim 8 wherein the first criterion comprises temporal proximity of each of the different temporal windows to a target temporal window.

11. The apparatus of claim 10 wherein the target temporal window comprises a future temporal window.

12. The apparatus of claim 11 wherein the weighting at least some of the historical information features differently for at least some of the historical information features according to at least a first criterion comprises, at least in part, weighting at least one of the different temporal windows that is closer to the future temporal window higher than another of the different temporal windows that is further from the future temporal window.

13. The apparatus of claim 8 wherein the first criterion comprises a weeks-of-stock parameter as corresponds to each of the different temporal windows.

14. The apparatus of claim 13 wherein weighting at least some of the historical information features differently for at least some of the historical information features according to at least a first criterion comprises, at least in part, weighting at least one of the different temporal windows having a weeks-of-stock parameter that is sufficiently similar to a weeks-of-stock parameter for a future temporal window higher than another of the different temporal windows having a weeks-of-stock parameter that is less similar to the weeks-of-stock parameter for the future temporal window.

15. The apparatus of claim 8 wherein the supply chain performance prediction machine learning model is configured to calculate at least one supply chain performance indicator threshold.

16. The apparatus of claim 15 wherein the supply chain performance prediction machine learning model is configured to calculate at least one supply chain performance indicator threshold by, at least in part, analyzing historical relationships between a case fill rate metric and a weeks of supply metric.

17. The apparatus of claim 16 wherein the supply chain performance prediction machine learning model is configured to calculate the at least one supply chain performance indicator threshold as a weeks of supply metric threshold that identifies a favorable future case fill rate metric.

18. A method comprising:
inputting information to a supply chain performance prediction machine learning model that has been trained, at least in part, with a training corpus formed by accessing historical information features that each comprise a supply chain performance indicator for each of a plurality of different temporal windows and weighting at least some of the historical information features differently for at least some of the historical information features according to at least a first criterion;
outputting from the supply chain performance prediction machine learning model a supply chain performance prediction regarding a future temporal window.

19. The method of claim 18, wherein the supply chain performance prediction machine learning model is configured to calculate at least one supply chain performance indicator threshold.

20. The method of claim 19 wherein the supply chain performance prediction comprises, at least in part, a weeks of supply metric that results in a favorable case fill rate metric for the future temporal window.
